(19) United States
(12) Patent Application Publication
(10) Pub. No.: US 2007/0128582 A1
(43) Pub. Date: Jun. 7, 2007

(54) Method, apparatus, and system for private lunar exploration

(75) Inventors: Eric Anderson, Arlington, VA (US); Christopher J. Faranetta, Alexandria, VA (US)

Correspondence Address: VENABLE LLP, P.O. BOX 34385, WASHINGTON, DC, 20043-9998, US

(73) Assignee: Space Adventures, Ltd., Vienna, VA (US)

(21) Appl. No.: 11/501,788

(22) Filed: Aug. 10, 2006

Related U.S. Application Data
(63) Continuation-in-part of application No. 10/510,822, filed on Aug. 1, 2005.
(60) Provisional application No. 60/706,749, filed on Aug. 10, 2005.

(51) Int. Cl. G09B 9/08; G06Q 10/00

(52) U.S. Cl. 434/30; 705/5

(57) ABSTRACT

A method of registering for private space travel to the moon, comprises providing a first spacecraft adapted to carry at least one private individual, receiving payment from the private individual for registration for a flight on the first spacecraft, providing launching of the first spacecraft from the earth carrying the private individual, and providing travel into lunar orbit for the private individual in the first spacecraft.

### CROSS-REFERENCE TO RELATED APPLICATIONS

The present application is a continuation-in-part of U.S. patent application Ser. No. 10/510,822, filed on Oct. 12, 2004, which is the U.S. National Stage of International Application No. PCT/US03/10891, filed Apr. 10, 2003. The present application also claims priority to U.S. Provisional Application No. 60/706,749, filed Aug. 10, 2005. The entire content of each of the aforementioned applications is expressly incorporated herein by reference.

### BACKGROUND OF THE INVENTION

1. Field of the Invention

The present invention relates generally to space flight, and more particularly, to methods of space exploration, and related training systems and apparati.

2. Background of the Invention

For years, man has been fascinated with space exploration and travel to foreign planets. Due to its proximity to Earth, the moon has been a space destination of particular interest. From 1968 to 1972, the Americans embarked on a series of missions that orbited and/or landed on the moon. These missions were known as the Apollo missions. Since these missions ended in 1972, however, no one has returned to the moon. Moreover, no civilians (i.e., private individuals) have ever been on a mission to the moon. Therefore, there remains a need for methods, apparati, and systems for sending civilians on space missions, in particular to the moon.

### SUMMARY OF THE INVENTION

The present invention addresses man's desire for space travel, and, in particular travel to the moon, by providing methods, apparati, and systems by which civilians (i.e., private individuals, corporate customers and governments) can pay to be a passenger on a space mission to the moon.

According to an exemplary embodiment of the present invention, a method of registering for private space travel to the moon, comprises providing a first spacecraft adapted to carry at least one private individual, receiving payment from the private individual for registration for a flight on the first spacecraft, providing launching of the first spacecraft from the earth carrying the private individual, and providing travel into lunar orbit for the private individual in the first spacecraft.

According to an exemplary embodiment, the method may further comprise providing for an at least partial orbit of the moon in the first spacecraft.

According to an exemplary embodiment, the method may further comprise providing for travel around the far side of the moon in the first spacecraft.

According to an exemplary embodiment, the method may further comprise providing for docking the first spacecraft to a space station while en route to the moon or the earth.

According to an exemplary embodiment, providing for docking comprises allowing the private individual to inhabit the space station for a period of time. The method can further comprise providing for departure from the space station and reentry to the first spacecraft by the private individual. The space station can comprise the International Space Station.

According to an exemplary embodiment, the method can further comprise providing for landing on the surface of the moon.

According to an exemplary embodiment, the method can further comprise providing for docking the first spacecraft with a second spacecraft in outer space. Providing for docking with a second spacecraft can comprise docking with a second spacecraft comprising a lunar module. The method can further comprise providing for landing the lunar module on the surface of the moon.

According to an exemplary embodiment, the method can further comprise providing a second spacecraft adapted for unmanned travel to at least one of the moon and the orbiting of the moon, launching the second spacecraft from the earth prior to launching the first spacecraft from the earth, and guiding the second spacecraft around the moon. Guiding the second spacecraft around the moon can comprise guiding the second spacecraft into at least one orbit of the moon.

According to an exemplary embodiment, the at least one private individual can be accompanied by at least one non-fee paying individual. The non-fee paying individual can comprise at least one of an American Astronaut and a Russian Cosmonaut.

According to an exemplary embodiment, the method can further comprise providing training of the private individual for space exploration prior to said launch of the first spacecraft from the earth. The private individual can provide payment for the training received. A computer can be used to receive payment from the private individual.

According to another exemplary embodiment, a lunar travel system comprises a first spacecraft adapted to carry at least one passenger, the first spacecraft adapted to depart from the earth and travel into the moon's orbit, wherein the at least one passenger comprises at least one fee-paying private individual.

According to an exemplary embodiment, the first spacecraft can be adapted to dock with a space station located in space. The space station can comprise the International Space Station.

According to an exemplary embodiment, the system can further comprise a lunar module dockable with the first spacecraft, wherein the lunar module is adapted to transport at least the private individual to the lunar surface.

According to an exemplary embodiment, the system can further comprise a third spacecraft adapted to fly unmanned into lunar orbit unmanned prior to departure of the first spacecraft from the earth.

According to an exemplary embodiment, the first spacecraft can be adapted to transport at least two passengers, at least one of which is a non-paying individual. The non-paying individual can be an American Astronaut or a Russian Cosmonaut.

According to an exemplary embodiment, the system can further comprise at least one of a computer-implemented online registration system adapted to register the at least one passenger, and/or a computer-implemented training system adapted to provide computer-assisted training of the at least one passenger relating to space flight.

Another exemplary embodiment of the present invention comprises a computer readable medium embodying logic, which when executed by processor performs a method comprising providing a first spacecraft adapted to carry at least one private individual, receiving payment from the private individual for registration for a flight on the first spacecraft, providing launching of the first spacecraft from the earth carrying the private individual, and providing travel into lunar orbit for the private individual in the first spacecraft.

### BRIEF DESCRIPTION OF THE DRAWINGS

The foregoing and other features and advantages of the invention will be apparent from the following, more particular description of a preferred embodiment of the invention, as illustrated in the accompanying drawings wherein like reference numbers generally indicate identical, functionally similar, and/or structurally similar elements.

FIGS. 1A-B illustrate an exemplary mission profile according to the present invention;

FIG. 1C illustrates a variation of the mission profile of FIGS. 1A-B;

FIGS. 2A-B illustrate another exemplary mission profile according to the present invention;

FIG. 3 illustrates yet another exemplary mission profile according to the present invention;

FIG. 4 illustrates an exemplary space ship for use in accordance with the present invention;

FIG. 5 illustrates an exemplary lunar module for use in accordance with the present invention;

FIG. 6 is a flow diagram illustrating an exemplary method of qualifying and training private individuals according to the present invention; and

FIG. 7 illustrates an exemplary computer system that can be used to implement the method(s) according to the present invention.

### DETAILED DESCRIPTION OF VARIOUS EXEMPLARY EMBODIMENTS

The foregoing and other features and advantages of the invention will be apparent from the following, more particular description of various exemplary embodiments, including a preferred embodiment of the invention, as illustrated in the accompanying drawings wherein like reference numbers generally indicate identical, functionally similar, and/or structurally similar elements.

As used herein the terms “civilian” and “private individual” shall be used interchangeably, and mean any person not employed as an astronaut, cosmonaut, or specialized flight person by a governmental space agency, government contractor, or military for the purpose of space flight or near-space flight travel. In one embodiment of the invention, the private individual may pay a fee. In another embodiment, the private individual can be a non-paying customer who wins a contest, such as, e.g., a lottery, sweepstakes, televised or live game show, or the like. Alternatively, the private individual can receive the opportunity for space travel through a gift, inheritance, redemption of frequent flier miles, or the like. In yet another embodiment, the private individual can be commercially or privately sponsored to seek space travel.

Flight Profiles and Mission Itineraries

According to one exemplary embodiment of the present invention, referred to as the Deep Space Expeditions (“DSE”) program, private individuals (such as fee paying customers) can embark on a mission to the moon. As part of the DSE program, the private individual may, among other things, orbit the moon, view the Earthrise from lunar orbit, and/or view the never-seen-from-Earth far side of the moon from an altitude of about 100 km.

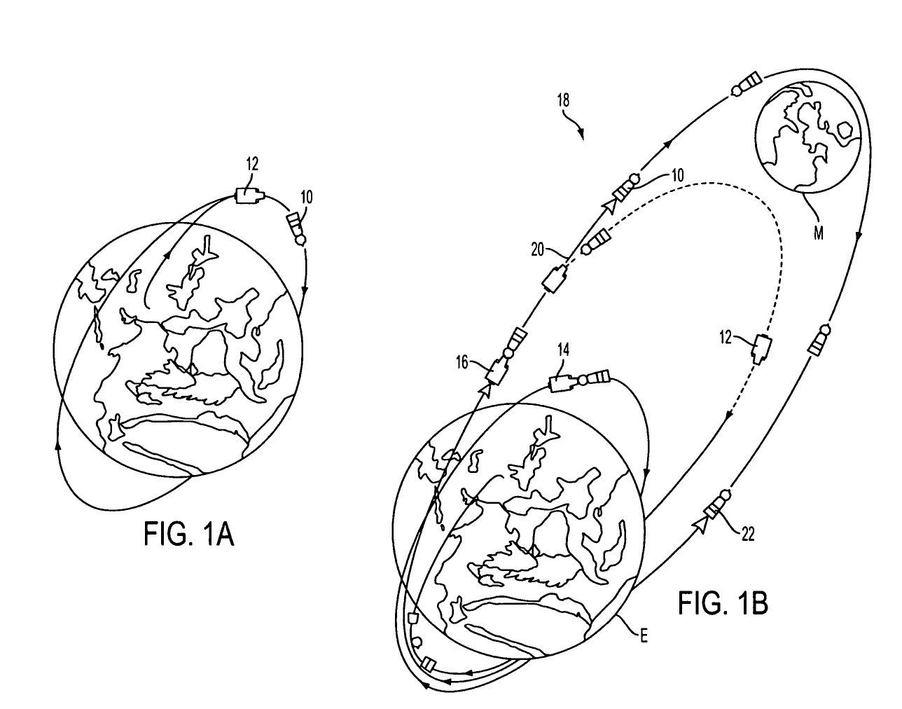

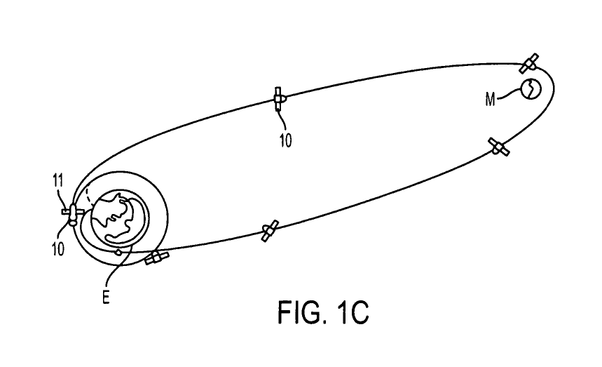

A flight plan for an exemplary embodiment of the DSE program, referred to as the “Direct Staged Mission,” is shown in FIGS. 1A and 1B. Prior to departure, the mission can include training. For example, the private individual can undergo training at the Yuri Gagarin Cosmonaut Training Center in Star City, Russia. The training can include the basics of becoming a cosmonaut, and can include training in a spacecraft simulator, such as, e.g., but limited to, a Soyuz spacecraft simulator. According to another exemplary embodiment, the total duration of the training program for the private individual can be dramatically reduced given that they may not visit the International Space Station and/or may not need to learn about its systems or comply with its training standards. Such an exemplary shortened training program can have greater appeal for, e.g., high net worth private individuals who are generally very pressed for time. Further exemplary details regarding pre-flight training are provided below under the heading “Training Programs.” Approximately two weeks prior to launch, the private individual(s) and crewmembers may arrive at the launch site, e.g., but not limited to, the Baikonur Cosmodrome in the Republic of Kazakhstan from a mobile Sea Launch platform based in the Pacific Ocean near the equator. Here, final preparations can be made for launch to low Earth orbit.

On launch day (i.e., day one), the private individual(s) and crew, typically totaling three people, can take off in a lunar-rated spaceship 10, such as, e.g., but not limited to, a Soyuz spacecraft. As shown in FIG. 1A, the spacecraft 10 may launch into the Earth's orbit. Typically on the day following launch day (i.e., day two), a second spacecraft, such as a Russian Proton K, Proton M or a Sea Launched Zenit 3 SL, containing a high-energy upper stage flight engine 12 may be launched into the earth's orbit. The upper stage 12 can be, for example, a Block DM, Block DMSL or Breeze M upper stage. While the upper stage 12 is parked in low Earth orbit, the spaceship 10 can head for a rendezvous with the upper stage 12.

Referring to FIG. 1B, typically on day three, the spaceship 10 and upper stage 12 may dock (see reference 14). Subsequently, the upper stage 12 may be ignited (see reference 16 on FIG. 1B) and may boost the spaceship 10 out of the Earth's orbit and towards the moon M. Once the upper stage 12 depletes its fuel source, it can unlatch from the spaceship 10 (see reference 20 on FIG. 1B), at which point the upper stage 12 may be jettisoned back to the Earth E. Subsequently, the spaceship 10 can issue a second burn (See reference 18 on FIG. 1B), further propelling the spaceship 10 toward the moon M. After a few days of travel toward the moon M (for example, by about day six), the spaceship 10 may pass by the moon M and may enter lunar gravity. At this point, the sunlit, far side of the moon M may be observed. The Earth E may also be observed over the horizon of the Moon M. Cameras, such as, e.g., but not limited to, high-definition cameras, may be used to record the views of the moon M and/or Earth E. As shown in FIG. 1B, the spaceship 10 may eventually pass by the moon M and may head back towards the Earth E. As the spaceship 10 approaches the Earth E (see point 22 in FIG. 1B), a reentry burn can be issued by the spaceship 10. At or around day nine, for example, the reentry component of the spaceship 10 can separate from the remainder of the spaceship 10, and return to the Earth E. Upon initial entry into the Earth's atmosphere the remainder of the spaceship, e.g., but not limited to, the reentry capsule can perform a skip off the Earth's atmosphere and then can completely reenter to perform a parachute landing. The atmospheric skip can be performed to reduce the heat load on the reentry capsule, reduce the gravity load on the reentry capsule, increase both the flight cross range and flight distance of the reentry, and can enable it to land around dawn in the recovery area. One of ordinary skill in the art will appreciate that the sequence and timing of events described above is exemplary and non-limiting, and that other sequences and schedules are possible.

FIG. 1C shows an alternative embodiment of the “Direct Staged Mission,” in which a rendezvous with an upper stage 12 is not utilized. For example, the spaceship 10 can launch from Earth E using a single booster; may orbit the Earth E one or more times; and then may issue a translunar boost to send the spaceship 10 onto the Earth departure leg. The remainder of the mission can be the same or substantially the same as that described above with respect to FIGS. 1A and 1B.

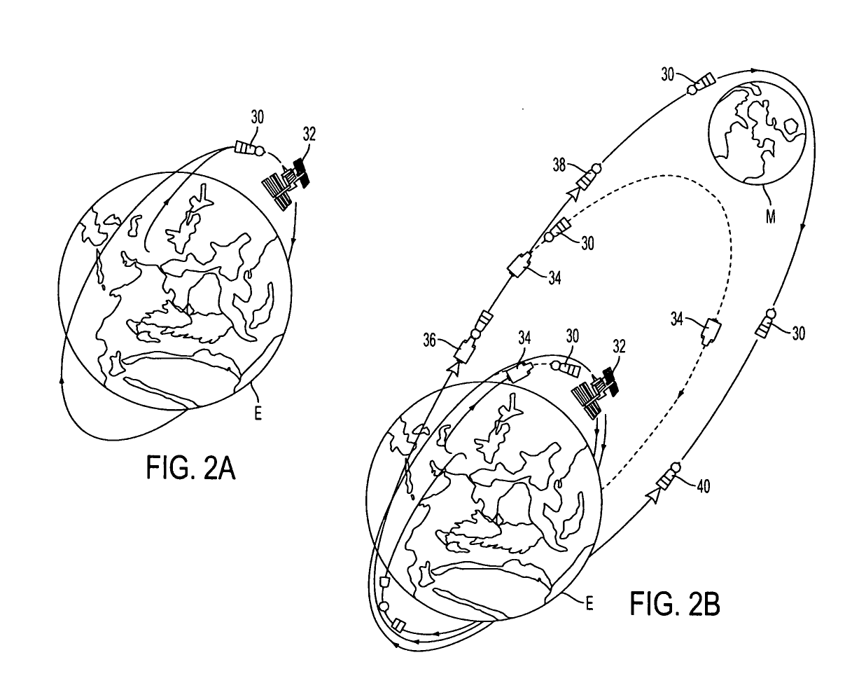

A flight plan for another exemplary embodiment of the DSE program, referred to as the “International Space Station (ISS) staged mission,” is shown in FIGS. 2A and 2B. Similar to the “direct staged mission,” described above, the ISS Staged Mission can include training. In addition to the training described above, the ISS staged mission can include training in, e.g., but not limited to, an ISS simulator, for example, at the Yuri Gagarin Cosmonaut Training Center in Star City, Russia. Further exemplary details regarding pre-flight training are provided below under the heading “Training Programs.” Approximately two weeks prior to launch, the private individual(s) and crewmembers (typically totaling three passengers) may arrive at the launch site, such as, for example, but not limited to, the Baikonur Cosmodrome in the Republic of Kazakhstan. Here, final preparations can be made for launch to dock with the ISS.

On launch day (i.e., day one), the private individual(s) and crew, typically totaling three people, can take off in a lunar-rated spaceship 30, such as, e.g., but not limited to, a Soyuz spacecraft. As shown in FIG. 2A, the spacecraft 30 may launch into the Earth's orbit, and may travel for about two days before docking with the ISS 32. Typically around day two or three, the spaceship 30 may dock with the ISS 32. Once docked with the ISS 32, the private individual(s) and crew can enter the ISS 32. There, they can meet the crew of the ISS 32, may tour the ISS 32, and may generally familiarize themselves with the ISS 32. The private individual(s) and crew can stay aboard the ISS 32 for varying amounts of time, where they can perform, e.g., but not limited to, a spacewalk or what is known as an extravehicular activity (EVA), but typically between ten and fourteen days. During this time, the private individual(s) can study the Earth E from space, may perform research projects (such as, e.g., but not limited to, researching the ISS' microgravity environment), and may participate in other activities.

Referring to FIG. 2B, a second spacecraft, such as, e.g., but not limited to, a Russian Proton K, Proton M or a Sea Launched Zenit 3 SL, containing a high-energy upper stage flight engine 34 may be launched into the earth's orbit. The upper stage 34 can be, for example, a Block DM, Block DM SL or Breeze M upper stage. While the upper stage 34 is parked in low Earth orbit, the spaceship 30 can undock from the ISS 32 and may head for a rendezvous with the upper stage 34. At or around day fifteen, for example, the spaceship 30 and upper stage 34 may dock. Subsequently, the upper stage 34 may be ignited (see reference 36 in FIG. 2B) and may boost the spaceship 30 out of the Earth's orbit and towards the moon M. Once the upper stage 34 depletes its fuel source, it can unlatch from the spaceship 30, at which point the upper stage 34 may be jettisoned back to the Earth E, in an exemplary embodiment. Subsequently, the spaceship 30 can issue a second burn (see reference 38 on FIG. 1B), further propelling the spaceship 30 toward the moon M. After a few days of travel toward the moon M (for example, by about day eighteen), the spaceship 30 may pass by the moon M and may enter lunar gravity. At this point, the sunlit, far side of the moon M may be observed. The Earth E may also be observed over the horizon of the Moon M. Cameras, such as, e.g., but not limited to, high-definition cameras, may be used to record the views of the moon M and/or Earth E. As shown in FIG. 2B, the spaceship 30 may eventually pass by the moon M and may head back towards the Earth E. As the spaceship 30 approaches the Earth E (see point 40 in FIG. 2B), a reentry burn can be issued by the spaceship 30. At or around day twenty-one, for example, the reentry component of the spaceship 30 can separate from the remainder of the spaceship 30, and may return to the Earth E. One of ordinary skill in the art will appreciate that the sequence and timing of events described above is exemplary and non-limiting, and that other sequences and schedules are possible. For example, according to another exemplary embodiment, the spaceship 30 can stay docked to the ISS 32 for about four days. According to this exemplary embodiment, the spaceship 30 can fly around the moon M at about day nine, and eventually land back on Earth E around day twelve.

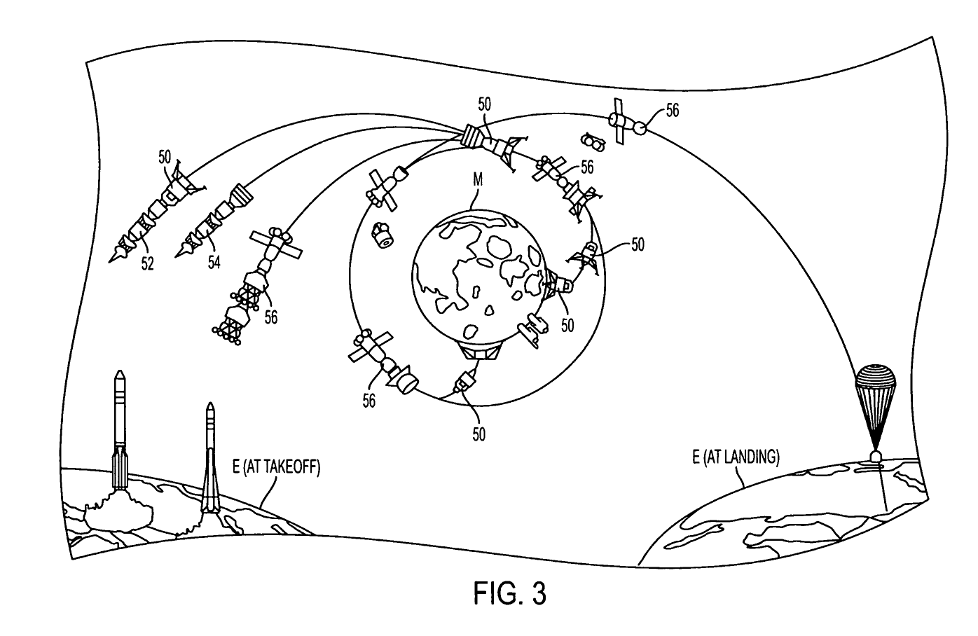

FIG. 3 depicts another exemplary embodiment of a DSE program, which can include a lunar landing. A lunar module 50 may be used to perform the lunar landing. An example of a lunar module that may be used is the “Eagle” lunar module that was used for the Apollo 11 mission to the moon in 1969. The lunar module 50 which may be used to support a lunar surface mission can be delivered to the moon using the following exemplary method.

First, a lunar module can be launched aboard, e.g., but not limited to, an Arian 5 ECA booster 52 from Kourou, French Guyana, for example, two months to two weeks before the launch of the crew. Once the lunar module 50 has reached lunar orbit, the decision can then be made to launch the upper stage 54 for the crew. The upper stage 54 can comprise a second Arian 5 ECA booster that may be launched, for example, but not limited to, from Kourou, French Guyana, and then may be parked in low Earth orbit awaiting launch of the crew. Once the health of the upper stage 54 has been confirmed, the crew (comprising, for example, three people) can be launched from Kourou, French Guyana, for example, aboard a spaceship 56, such as, e.g., but not limited to, a Soyuz FG launch vehicle. The crew aboard the spaceship 56 can comprise a professional cosmonaut pilot and, e.g., but not limited to, one to two (or more) private individuals. The spaceship 56 can then rendezvous and may dock with the upper stage 54, and may be propelled to the moon M.

Once the spaceship 56 reaches lunar orbit, it can rendezvous with the lunar module 50 and may undock from the upper stage 54. The spaceship 56 can then dock to the lunar module 50 and a crew of, for example, but not limited to, one professional cosmonaut pilot and one private individual can board the lunar module 50 and may descend to the surface of the moon M. The third crew member can remain aboard the space ship 56 in lunar orbit, or may have the option of descending to the surface with the other two crew members.

Once done exploring the surface of the moon M, the lunar module (and crew) can return from the surface of the moon M to rendezvous with the space ship 56. In the event that the lunar module 50 is not placed into the correct orbit during its launch from the lunar surface, the lunar module upper stage can be used to rendezvous with the space ship 56. The upper stage may then be used to place the lunar module 50 into the correct orbit with the space ship 56. Both the lunar module 50 and space ship 56 can then rendezvous and dock, and, e.g., all crew can transfer to the space ship 56. If the lunar module 50 is unable to dock with the space ship 56 upon its return from the lunar surface, the crew has the option of independent Earth return and may park in Earth's orbit by the use of an inflatable aerobraking shell (not shown). Once safely in low Earth orbit, the lunar module crew may be rescued by a second space ship (not shown), which may be launched, for example, but not limited to, from Kourou, French Guyana.

Once the crew is aboard the space ship 56, it can jettison the lunar module 50 and may subsequently rendezvous and may dock with its upper stage 54, which can fire and send the space ship 56 on its return to Earth. In the event the upper stage 54 malfunctions, the space ship 56 may have the option of using the lunar module's upper stage to deliver the space ship 56 on its return to Earth E.

After the upper stage 54 has fired, and the space ship 56 is in transit to Earth E, the space ship can undock from the upper stage 54. The upper stage 54 can then perform a collision avoidance maneuver. Once in the Earth's atmosphere, the space ship 56 reentry capsule can perform a skip on the night side of the Earth. The skip can allow the capsule to perform a plane change, may reduce heat loads and g-loads, and may land on land during maximum daylight, for example, but not limited to, in the steppes of Kazakhstan.

Spacecraft and Related Equipment

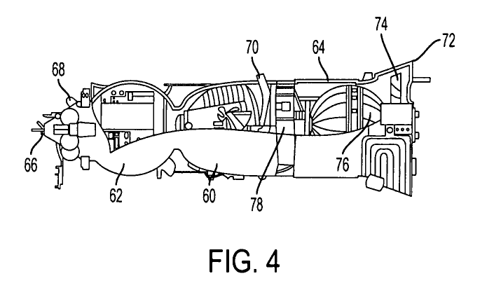

FIG. 4 is a representation of an exemplary space ship that can be used, for example, in the above-described missions. The space ship can comprise a descent capsule 60, an orbital module 62, and one or more propulsion modules 64. The space ship can also comprise a docking unit 66. The space ship can also comprise a plurality of thrusters, such as a maneuvering thruster 68, a docking thruster 70, and a maneuvering thruster 72. The space ship can also comprise a power system 74, a fuel tank 76, and an avionics compartment 78.

The following modifications can be implemented to enable a conventional Soyuz TMA to be modified for use in a circumlunar mission:
A star tracker can be added to the guidance navigation and control system.
The telecommunications system can be modified to support communications from deep space.
The thickness of the reentry heat shield can be increased to support faster reentry speeds and greater heat loads.
The service life of the life support system (e.g., atmospheric revitalization system, waste collection system, and water and food supplied) can be extended.

The upper stage described above can be, for example, a conventional Block DM, Block DMSL or Breeze M upper stage. However, it can be desirable to modify the conventional upper stage in the following exemplary ways:
installation of a passive docking assembly
installation of rendezvous and docking devices.

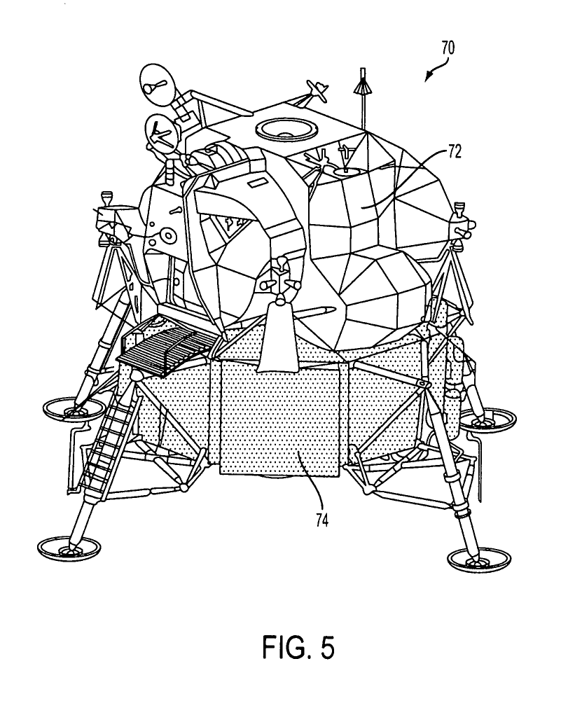

FIG. 5 is a schematic representation of an exemplary lunar module 70 that may be used in the above-described missions. The lunar module 70 can include two parts or stages which are joined together by interstage fittings. The upper portion of the lunar module is the ascent stage 72. It can carry the passengers as well as the navigation, guidance, control, communications, life support, environmental control, electrical power, propulsion, and other systems. The lower portion of the lunar module 70 is the descent stage 74. It can carry scientific equipment, a propulsion system, additional electric power, water and oxygen for the ascent stage 72. At the end of a lunar visit, the interstage fittings can be severed (for example, by an explosive device). This may allow the ascent stage 72 to lift off and return the crew to an orbiting space ship, while the descent stage 74 may remain on the moon. The ascent stage 72 can dock with the orbiting space ship, allowing the crew to return to the space ship. The lunar module 70 can then be jettisoned into the moon's orbit and set to crash into the moon's surface at a predetermined time.

The following additional or alternative launch vehicles and methods can also be used to support the missions described above:
Proton M launch vehicle with Breeze M upper stage
Proton K launch vehicle with Block DM upper stage
Sea launched Zenit 3 SL launch vehicle with Block DM SL upper stage
An enlarged optical quality window can be added to the side habitation module of the space ship to support observation, high-definition videography, and photography of the moon
An enlarged optical quality window can be added to the space ship by docking it to an upper stage that may be used to transport the space ship to the moon;

the window can be delivered by the upper stage, and may be left behind once the upper stage has been fired, burned to completion and jettisoned; the window could remain attached to the docking port nose of the space ship.

One of ordinary skill in the art will know that the flight profiles, mission itineraries, and other methods described herein are not limited to use with the above-described spacecrafts.

Training Programs

The following methods can be used when qualifying a private individual for space exploration. During the qualification process, an administering body (e.g., Space Adventures, Ltd.) can, for example, recruit a private individual, guide the private individual through the medical and training qualification process while monitoring the private individual's progress, and then can evaluate the private individual to determine whether the private individual is qualified for space flight. After completing the qualification process, in one embodiment of the invention, the administering body may also administer medical screening and training for space exploration. In yet another embodiment of the invention, the administering body can take the private individual on a space mission.

For example, in one exemplary embodiment of the invention, the private individual can enroll in the space flight qualification program for a fixed amount of days, for example, but not limited to, ten days, and be medically qualified and qualified to train for space exploration. The space training can then be completed independent of the qualification program, for example, over the next six months. Upon completion of the training, the private individual can then seek space flight. In another embodiment of the invention, the qualification and training program can be completed simultaneously over a period of, for example, but not limited to, ten to fourteen days. Upon completion of the qualification/training program, the private individual can then take a space trip, such as, those described above.

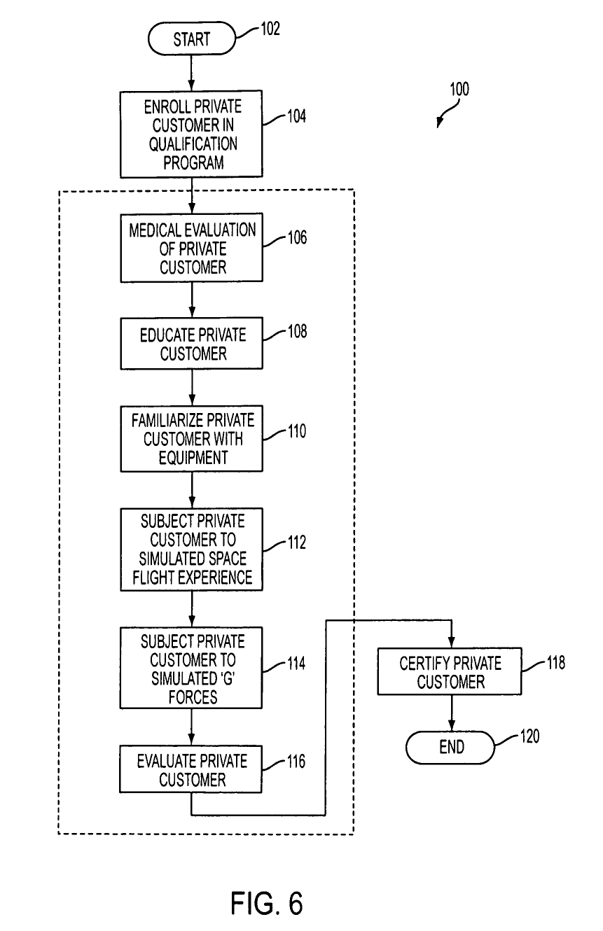

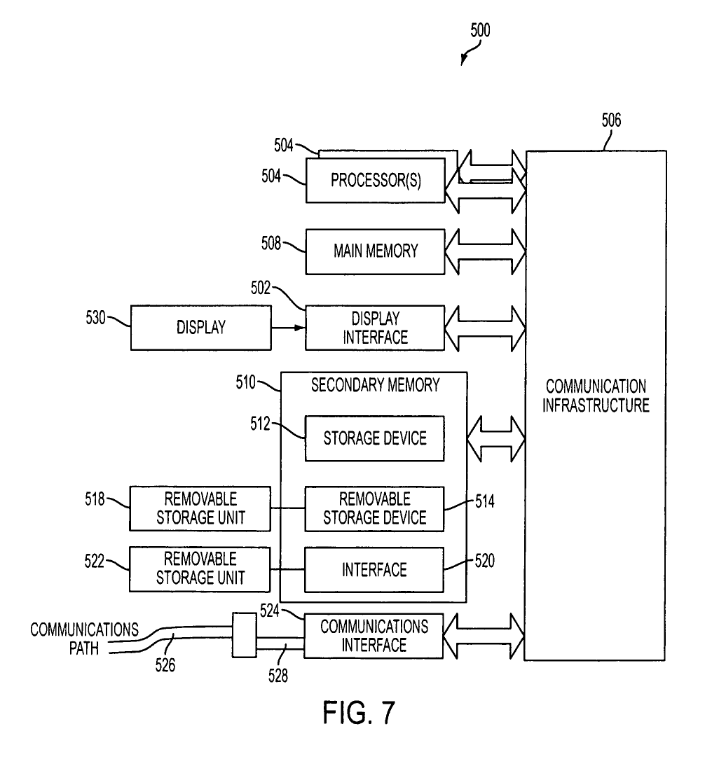

Referring now to FIG. 6, an exemplary method 100 for qualifying a private individual for space exploration is illustrated. The flow diagram can begin with start step 102 and may proceed to enrollment step 104. In enrollment step 104, the private individual can enroll in the qualification program. Enrollment step 104 can include having the private individual fill out an application and medical questionnaire and may include computer-assisted assessment of the private individual based on his or her background, associations and/or motivations for desiring space travel. The application can be, for example, a written application (which may be electronically scanned using, e.g., but not limited to, optical character recognition (OCR), etc.), an online application, a telephone-accessed application or the like. In filling out the application, the private individual may be required to disclose any and all personal information including, e.g., but not limited to, his or her name and address, date of birth, educational background, criminal record, professional/work experience, and the like. The medical questionnaire may require the private individual to disclose all relevant medical information including personal medical history, family medical history, and any other medical information. The medical questionnaire may also require the private individual to obtain a physical and/or detailed preliminary medical work-up that may be separate from the following medical evaluation step 106 to obtain information which may be necessary to complete the medical questionnaire. In assessing the private individual, the certifying body, e.g., Space Adventures, of Vienna, Va., U.S.A. can use information obtained during the enrollment process to evaluate the private individual to determine, for example, if the customer has the proper motivations for desiring space flight. A computer or computer system (for example, but not limited to, computer system 500 described further below with reference to FIG. 7) may be used to facilitate the enrollment process.

After completion of enrollment step 104, may come exemplary qualification step (as indicated by the dashed box) of the space flight qualification program. The qualification steps of the space flight qualification program can include medical evaluation step 106, education step 108, flight related equipment familiarization step 110, simulated space environment step 112, simulated “G”-forces step 114, and evaluation step 116. The process may end with certification step 118. In one embodiment, the qualification steps can be completed in an order, for example, as shown in FIG. 6, or alternatively, can proceed in any order in a simultaneous or non-simultaneous manner with or without interruption. The qualification steps can also be completed in a fixed amount of time, for example, 3 or 10 days, or alternatively, can span over an undesignated amount of time, such as, e.g., 6 months to a year. The private individual may be free to enroll in a program of his or her choosing, or may be required to enroll in particular program depending on the private individual's goals with respect to achieving actual space flight. The qualification steps can be carried out at any space flight training facility, such as, for example, but not limited to, the Yuri Gagarin Cosmonaut Training Center.

Medical evaluation step 106 can include any thorough battery of tests sufficient to cause a trained professional to determine whether the private individual is fit for space flight. The battery of tests can include, without limitation, a complete blood analysis, a general exam by an otolaryngologist (ENT), a general exam by a neurologist, a general exam by a dentist, a general psychological exam by a psychologist, an electrocardiogram, an echocardiogram, an auditory system test, a passive posture test (topography diagnosis of blood system and cardiovascular systems, oscillography), a psychological screening, personality testing, determining the non-stop and continuous cumulating effects of Coriolis acceleration, determining the discontinuous cumulating effects of Coriolis acceleration, esophagigastroduodenascopic (Upper GI) series, a complete set of X-rays, 24-hours of electrocardiogram (EKG) monitoring, a colonoscopy, endoscopic ultrasonograph of inner organs, a spinal X-ray, and a visual exam.

During education step 108, the private individual can be educated about aspects of space flight to the extent necessary to evaluate suitability for space flight, including, but not limited to the physics of space flight, spacecraft operation, space station operation, orbital mechanics, astronomy, aeronautical engineering, and emergency procedures. The education of the private individual can be accomplished in several ways including without limitation lectures by spacecraft engineers, lectures by spacecraft architects, lectures by former and current cosmonauts/astronauts, lectures by test pilots, lectures by doctors and medical personnel, studying from books written on the subject of spacecraft operation, studying from books written on the subject of space flight, using computer software designed to instruct the private individual in orbital mechanics, using of computer software designed to instruct the private individual in flight profiles, and using a planetarium or celestial projection system.

During flight related equipment familiarization step 110, the private individual can be exposed to space flight related equipment to the extent necessary to evaluate suitability for space exploration. The purpose of this step is to expose the private individual to the experience of the interior of their space flight vehicle including without limitation, the cockpit, passenger cabin, flight controls, cargo bay, and the like, as well as other equipment including without limitation the space suit and other non-spacecraft systems. The exposure can include, for example, being placed around and inside a stationary simulated spacecraft, and/or around and inside an actual spacecraft, training with computer systems designed to simulate spacecraft, and/or training with simulated components of a spacecraft, and/or training with actual components of a spacecraft, and/or training with simulated equipment used for space flight, and/or training with actual equipment and software used for space flight, and exposure to any other actual or simulated space flight related equipment.

During simulated space environment step 112, the private individual can be subject to simulation of the experiences of space flight, as well as other actual or simulated environments related to all aspects of space exploration. The purpose of this step is to acclimate the private individual to the various environments of space exploration, such as, e.g., changes in temperature, the claustrophobic nature of the spacecraft, changes in pressure inside the spacecraft, the lighting conditions, e.g., the lack of light inside the spacecraft, and emergency landing environments. The private individual can also be acclimated to the varying conditions of decreased and increased gravity as it relates to operations inside the spacecraft. For example, the private individual can be placed inside a jet aircraft at high altitudes, and/or around and inside a simulated spacecraft while the spacecraft is submerged under water, and/or around and inside an actual spacecraft while the spacecraft is submerged under water, and/or around and inside simulated spacecraft while inside an aircraft following a parabolic flight profile, and/or around and inside an actual spacecraft while inside an aircraft following a parabolic flight profile, and/or around and inside a simulated spacecraft while inside a hypobaric chamber, and/or around and inside an actual spacecraft while inside a hypobaric chamber, and/or around and inside an actual spacecraft while situated in launch configuration on a launch pad, and/or experiencing decompression inside a hypobaric altitude chamber, and/or experiencing hypoxia inside a hypobaric altitude chamber. Additionally, the private individual can conduct survival training in the desert, frozen tundra, forest, or water to simulate alternate emergency landing environments. These emergency landing environments can either be actual or simulated.

The space environment step 112 can include simulated “G”-forces or they can be provided in a separate step 114. During simulated “G”-forces step 114, the private individual can be subjected to various simulated “G”-forces, such as, e.g., increased and/or decreased “G”-forces and microgravity environments. Examples of these simulated “G”-forces can include without limitation, experiencing increased “G”-forces aboard a centrifuge, experiencing increased “G”-forces aboard a jet aircraft, experiencing increased and decreased “G”-forces aboard an aircraft flying a parabolic flight profile, experiencing decreased “G”-forces submerged in a tank and weighted to achieve neutral buoyancy, and experiencing decreased “G”-forces while skydiving from an aircraft.

During evaluation step 116, the administering body, alone or in conjunction with other organizations, can comprehensively evaluate the private individual to determine whether the private individual is qualified or unqualified for space exploration based on the private individual's completion of any or all of the aforementioned steps. The criteria used to evaluate the private individual can be independently developed by the administering body or based on some other standard for space flight qualification, or the like.

During certification step 118, the administering body, e.g., Space Adventures, can certify that the private individual is qualified for space flight. If the private individual is not qualified for space flight, the administering body may choose not to certify the private individual for space flight. Certification step 118 can include, for example, the private individual receiving a certificate of achievement, receiving of a letter of rejection if the private individual is not qualified, receiving an award, i.e. wings, receiving a monetary award, receiving a physical or verbal invitation to continue training, receiving a contract for an actual space flight, receiving a compiled and edited video documenting the qualification process, presented in either DVD or similar format, and receiving an album of photographs of the qualification process. Upon completion of certification step 118, flow diagram 100 can end at step 120.

Space travel may not be available at a given time, for example due to the tragic loss of the Columbia space shuttle, or because suborbital vehicles are not widely available. Accordingly, an aspect of the invention may involve taking payment from customers in advance, conducting qualification and possibly training according to the invention, and holding a place when it becomes available while holding the necessary customer funds in escrow. This can be done, for example, with the assistance of a computer or computer system.

Certification of suitability according to the invention may have independent value as recognition that the customer has, as the popular saying goes, “the right stuff” to be an astronaut, whether or not the individual ever flies to space. Also, the qualification process of the invention, whether or not the customer receives certification, may satisfy a demand for recreational, educational, and entertainment activities, such as, e.g., but not limited to being employed as part of a game show, and as shown in the following examples.

(A) Suborbital Flight Program

In an embodiment involving sub-orbital flight, an administering agency such as Space Adventures may make sub-orbital space flight possible by collaborating with several independent corporations who may each be developing their own version of a Reusable Launch Vehicle (RLV). Space tourism flights aboard these RLVs may begin in the near term. Prior to the start of regular space tourism flights, each RLV may be rigorously tested and may be licensed for operation in accordance with safety standards set by Space Adventures and all relevant local government regulations.

With the same anticipation and excitement that astronauts and cosmonauts experience before their orbital space launch, the flight specialists may help the customer don a flight suit and may guide him or her through the final launch checklist. The launch may begin under the watchful eye of a pilot and/or precise control of system equipment. In an unprecedented sensory experience, rocket motors may boost the RLV beyond the normal limits of flight to regions above 62 miles (100 kilometers). As the RLV nears maximum altitude, the rocket engines may be shut down and may allow the customer to experience up to five minutes of continuous weightlessness and may see the vast blackness of space set against the blue limits of Earth below. To commemorate completion of this 30-90 minute space experience, Space Adventures, as an example of the administering body, may award, as an example, Space Adventures astronaut wings and a lifetime membership in the Exeo-Atmosphere Club, an exclusive private club for those who have experienced space flight first hand.

The sub-orbital flights may be preceded by a detailed four-day flight preparation and training program. This highly focused and inspiring pre-flight program may familiarize the customer with, e.g., but not limited to, the RLV flight program, critical vehicle systems, flight operations, zero-gravity training, in-flight gravity loads, and space flight safety procedures. Specifically, created under the direction of expert advisors and aerospace specialists, the flight-training program may be derived from the experiences and lessons learned in preparing both astronauts and cosmonauts for space flight. The primary objective of the training may focus on ensuring safety and maximizing enjoyment once in-flight. An exemplary schedule is as follows.

Day One: Meet Flight Team

Morning
Breakfast
Program briefing and orientation
Health screening by staff Flight Surgeon
Afternoon
   Space Adventures sponsored lunch
   Introduction to fellow flight program participants and flight crew
   Briefing on the flightsuit's safety features, operation and fitting of your flight suit
   Photo session: Flight Team photo session with flight crew
   Tour and operations briefing on Spaceport
   Briefing on astronaut and cosmonaut training philosophies
   Training session on zero gravity, including its effects, flight characteristics, and flight enhancement pointers
Evening
   Flight Team four course dinner and entertainment
   Optional astronomy presentation and viewing, with the chance to enjoy the brilliant night sky through a state-of-the-art telescope
      Day Two: Sub-Orbital Vehicle & Safety Training
Morning
   Breakfast
   Program briefing presentation question/answer session
   Tour of reusable launch vehicle (RLV)
   Training and briefing on RLV safety procedures and systems
   Inspection and briefing on RLV propulsion systems, reaction control systems and sub-orbital flight mechanics/profile
   Training aboard centrifuge to simulate gravity loads experienced during the sub-orbital flight
   Final health certification for flight
Afternoon
   Lunch
   Program briefing on the upper-orbital space environment
   Briefing and operations of inter-cabin communications and the health monitoring devices
   Flight couch customization-and-fit check aboard RLV, familiarization with RLV interior and exterior camera personal console operations
   Familiarization of science payload operations
Evening
   Pre-Spaceflight Dinner Gala
   Feature entertainment and post-dinner optional activities
      Day Three: Flight Simulation
Morning
   Program briefing on zero gravity RLV simulator aboard zero gravity training aircraft. The Flight Team will experience virtual reality simulations of the sub-orbital flight during parabolic flight training exercises. Debriefing on zero gravity training flight.
Brunch
   Simulations include in-flight aborts, camera and science payload operations
   Safety training review aboard RLV
   Review and operation of inter-cabin communications and health monitoring devices
   Review of RLV interior and exterior cameras and personal console operations
   Review of science payload operations
   Selection of science payload specialist and team leader by training staff
Afternoon
   Optional activities
Evening
   Sponsored dinner
   Feature presentation: Space Tourism: The Next 20 Years
   Following dinner: participate in an interactive astronomy session
      Day Four: Liftoff from Earth to Space
Morning
   Traditional Astronaut Steak and Eggs Breakfast (vegetarian options available)
   Program pre-flight briefing
Following breakfast:
   RLV inspection with flight crew
   Suit up and emergency life support systems check
   Video/photo session with launch vehicle
   Final safety training review aboard RLV
   Review pre-flight checklist with flight crew through intercom system
Afternoon
   Main Events of Countdown and Launch of RLV
   Flight Team experiences all phases of propulsion system boost, travels over twice the speed of sound and feels the gravity load increase as the RLV accelerates through the beginning of its 30-90 minute sub-orbital space flight.
   View limits of Earth, and the vastness of the universe beyond Earth's atmosphere at an altitude of over 62 miles (100 km).
   Flight Team creates their own customized video of the astronaut experiences using interior and exterior camera array on RLV.
   Science Payload Specialist activates scientific sampling and monitoring experiments
   Experience up to five minutes of continuous weightlessness while “free-floating” in cabin
   Observe the RLV ionization glow during hypersonic re-entry and feel the gravity load increase as the vehicle decelerates in the atmosphere
   Landing Celebration: Flight Team is greeted by family, friends and staff following sub-orbital landing
   Review of raw video footage from flight for editing and customization of personalized flight videos
Evening
   Gala
   Reception and Awards Dinner, black tie optional
   Special induction ceremony honoring the Flight Team
   Presentation of Astronaut Wings
   Flight Team is inducted into a private club
      (B) Orbital Flight Qualification Program

In another embodiment of the invention, a private individual can qualify to fly to the International Space Station (ISS) without having to be a career astronaut or cosmonaut. Space Adventures has worked since August 1999 with the Russian Space Agency, RSC Energia, and the Yuri Gagarin Cosmonaut Training Center to develop private flights to the ISS. A private customer who has the determination, resources, and can meet the requirements may be able to join the elite group of space explorers.

An example of an orbital qualification program (OQP) can include:
full medical assessment conducted prior to a full cosmonaut medical to detect and correct any potentially disqualifying medical issues.
full cosmonaut medical certification
chartered zero gravity flight
MiG-25 and 29 supersonic flights
neutral buoyancy and Soyuz spacecraft training
NOMEX flight suit and leather flight jacket
all transfers, meals, tours, and executive suite accommodations at the five-star Hotel
VIP processing, guides, staff support and interpreters OQP Prerequisites:
Complete medical assessment conducted prior to a full cosmonaut medical
Current medical history and documentation prior to medical exam
Medical certification from physician for MiGs and Zero Gravity flights
Diving certification for neutral buoyancy

Details:
Participants must be available for two weeks of medical examination and training in Moscow
All medical examinations and tests will be conducted at IMBP and GCTC facilities in the Moscow area.
Cosmonaut training activities will be conducted at the Yuri Gagarin Cosmonaut Training Center in Star City.

Additional tours can be scheduled after daily required activities as the schedule allows.

Sample Itinerary

Individuals wishing to embark on a Soyuz space flight may need to be flight certified by the Russian Space Agency. Space Adventures can offer an Orbital Flight Qualification Package to anyone wishing to participate in a space flight experience. This approach involves the technical facilities of the Yuri Gagarin Cosmonaut Training Center (Star City) and the State Research Center of the Russian Federation Institute of Biomedical Problems (IMBP). An exemplary itinerary is as follows.

Day One: VIP transfer from airport to the five-star Sheraton Palace Hotel in downtown Moscow; dinner and orientation

Day Two: Driving tour of the major highlights of Moscow; after lunch, transfer to Star City for a tour of the Yuri Gagarin Cosmonaut Training Center

Day Three: Comprehensive medical exam begins; over the next several days the customer experiences one of the most thorough medical exams of his or her life; complete blood tests, heart tests, neurological tests, dental tests, auditory tests, and comprehensive body scans; other highlights can include:
non-stop and continuous cumulating effects of Coriolis acceleration
discontinuous cumulating of Coriolis accelerations
4-8 Gs inside TsF-18 Centrifuge
Hypobaric Altitude chamber

Day Eleven: Transfer to Star City for chartered Zero-Gravity flight; usually twelve people are taken up at a time, but this can be a private trip for the customer; Soyuz Simulator training in the afternoon with practice docking with the ISS

Day Twelve: The committee gives their summary and conclusions on cosmonaut medical certification; individual is then transferred to Zhukovsky Air Base for MiG-25 and MiG-29 flights

Day Thirteen: Transfer to Star City for a full day Neutral Buoyancy training using the Orlan-M spacesuit; in the evening, celebrate accomplishments at special dinner in your honor

Day Fourteen: Check out of hotel; VIP transfer and departure processing at the airport.

Availability of ISS Flights:

This OQP can provide the private individual with an understanding of the challenges to be faced and qualification as to whether the customer meets the prerequisites. This can lead to arrangements for orbital space flight, if the opportunity arises and the individual decides to pursue it. The final medical examinations and qualification procedures are stringent, and the training sessions are physically and mentally demanding. Not everyone was meant to fly into space, but as we pass the 40th anniversary of the first manned space flight, according to the invention, private citizen explorers have the opportunity to qualify to visit an orbiting space station.

Computer Systems

An example of a computer system 500 is shown in FIG. 5. The computer system 500 may be useful for implementing one or more portions of the present invention. Specifically, FIG. 5 illustrates an example computer 500, which in an exemplary embodiment may be, e.g., (but not limited to) a personal computer (PC) system running an operating system such as, e.g., (but not limited to) WINDOWS MOBILE™ for POCKET PC, or MICROSOFT® WINDOWS® NT/98/2000/XP/CE/, etc. available from MICROSOFT® Corporation of Redmond, Wash., U.S.A., SOLARIS® from SUN® Microsystems of Santa Clara, Calif., U.S.A., OS/2 from IBM® Corporation of Armonk, N.Y., U.S.A., Mac/OS from APPLE® Corporation of Cupertino, Calif., U.S.A., etc., or any of various versions of UNIX® (a trademark of the Open Group of San Francisco, Calif., USA) including, e.g., LINUX®, HPUX®, IBM AIX®, and SCO/UNIX®, etc. However, the invention may not be limited to these platforms. Instead, the invention may be implemented on any appropriate computer system running any appropriate operating system. In one exemplary embodiment, the present invention may be implemented on a computer system operating as discussed herein. An exemplary computer system, computer 500 is shown in FIG. 5. Other components of the invention, such as, e.g., (but not limited to) a computing device, a communications device, a telephone, a personal digital assistant (PDA), a personal computer (PC), a handheld PC, client workstations, thin clients, thick clients, proxy servers, network communication servers, remote access devices, client computers, server computers, routers, web servers, data, media, audio, video, telephony or streaming technology servers, etc., may also be implemented using a computer such as that shown in FIG. 5.

The computer system 500 may include one or more processors, such as, e.g., but not limited to, processor(s) 504. The processor(s) 504 may be connected to a communication infrastructure 506 (e.g., but not limited to, a communications bus, cross-over bar, or network, etc.). Various exemplary software embodiments may be described in terms of this exemplary computer system. After reading this description, it will become apparent to a person skilled in the relevant art(s) how to implement the invention using other computer systems and/or architectures.

Computer system 500 may include a display interface 502 that may forward, e.g., but not limited to, graphics, text, and other data, etc., from the communication infrastructure 506 (or from a frame buffer, etc., not shown) for display on the display unit 530.

The computer system 500 may also include, e.g., but may not be limited to, a main memory 508, random access memory (RAM), and a secondary memory 510, etc. The secondary memory 510 may include, for example, (but not limited to) a hard disk drive 512 and/or a removable storage drive 514, representing a floppy diskette drive, a magnetic tape drive, an optical disk drive, a compact disk drive CD-ROM, etc. The removable storage drive 514 may, e.g., but not limited to, read from and/or write to a removable storage unit 518 in a well known manner. Removable storage unit 518, also called a program storage device or a computer program product, may represent, e.g., but not limited to, a floppy disk, magnetic tape, optical disk, compact disk, etc. which may be read from and written to by removable storage drive 514. As will be appreciated, the removable storage unit 518 may include a computer usable storage medium having stored therein computer software and/or data.

In alternative exemplary embodiments, secondary memory 510 may include other similar devices for allowing computer programs or other instructions to be loaded into computer system 500. Such devices may include, for example, a removable storage unit 522 and an interface 520. Examples of such may include a program cartridge and cartridge interface (such as, e.g., but not limited to, those found in video game devices), a removable memory chip (such as, e.g., but not limited to, an erasable programmable read only memory (EPROM), or programmable read only memory (PROM) and associated socket, and other removable storage units 522 and interfaces 520, which may allow software and data to be transferred from the removable storage unit 522 to computer system 500.

Computer 500 may also include an input device such as, e.g., (but not limited to) a mouse or other pointing device such as a digitizer, and a keyboard or other data entry device (none of which are labeled).

Computer 500 may also include output devices, such as, e.g., (but not limited to) display 530, and display interface 502. Computer 500 may include input/output (I/O) devices such as, e.g., (but not limited to) communications interface 524, cable 528 and communications path 526, etc. These devices may include, e.g., but not limited to, a network interface card, and modems (neither are labeled). Communications interface 524 may allow software and data to be transferred between computer system 500 and external devices. Examples of communications interface 524 may include, e.g., but may not be limited to, a modem, a network interface (such as, e.g., an Ethernet card), a communications port, a Personal Computer Memory Card International Association (PCMCIA) slot and card, etc. Software and data transferred via communications interface 524 may be in the form of signals 528 which may be electronic, electromagnetic, optical or other signals capable of being received by communications interface 524. These signals 528 may be provided to communications interface 524 via, e.g., but not limited to, a communications path 526(e.g., but not limited to,a channel). This channel 526 may carry signals 528, which may include, e.g., but not limited to, propagated signals, and may be implemented using, e.g., but not limited to, wire or cable, fiber optics, a telephone line, a cellular link, an radio frequency (RF) link and other communications channels, etc.

Embodiments of the present invention may include apparatuses for performing the operations herein. An apparatus may be specially constructed for the desired purposes, or it may comprise a general purpose device selectively activated or reconfigured by a program stored in the device.

Embodiments of the invention may be implemented in one or a combination of hardware, firmware, and software. Embodiments of the invention may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, etc.), and others.

Some or all of the above-mentioned steps, activities, flight profiles, and equipment can be combined to provide the lunar expeditions of the present invention. It is contemplated within the scope of the invention that the method steps outlined herein and described in the annexes may be carried out as disclosed or in any order that would provide lunar expeditions for fee-paying private individuals.

What is claimed:

1. A method of registering for private space travel to the moon, comprising:
providing a first spacecraft adapted to carry at least one private individual;
receiving payment from the private individual for registration for a flight on the first spacecraft;
providing launching of the first spacecraft from the earth carrying the private individual; and
providing travel into lunar orbit for the private individual in the first spacecraft.

2. The method of claim 1, further comprising providing for an at least partial orbit of the moon in the first spacecraft.

3. The method of claim 1, further comprising providing for travel around the far side of the moon in the first spacecraft.

4. The method of claim 1, further comprising providing for docking the first spacecraft to a space station while en route to the moon or the earth.

5. The method of claim 4, wherein said providing for docking comprises allowing the private individual to inhabit the space station for a period of time.

6. The method of claim 5, further comprising providing for departure from the space station and reentry to the first spacecraft by the private individual.

7. The method of claim 5, wherein the space station is the International Space Station.

8. The method of claim 1, further comprising providing for landing on the surface of the moon.

9. The method of claim 1, further comprising providing for docking the first spacecraft with a second spacecraft in outer space.

10. The method of claim 9, wherein providing for docking with a second spacecraft comprises docking with a second spacecraft comprising a lunar module.

11. The method of claim 10, further comprising providing for landing the lunar module on the surface of the moon.

12. The method of claim 1, further comprising:
providing a second spacecraft adapted for unmanned travel to at least one of the moon and the orbiting of the moon;
launching the second spacecraft from the earth prior to launching the first spacecraft from the earth; and
guiding the second spacecraft around the moon.

13. The method of claim 12, wherein said guiding the second spacecraft around the moon comprises guiding the second spacecraft into at least one orbit of the moon.

14. The method of claim 1, wherein the at least one private individual is accompanied by at least one non-fee paying individual.

15. The method of claim 14, wherein the non-fee paying individual comprises at least one of an American Astronaut and a Russian Cosmonaut.

16. The method of claim 1, further comprising providing training of the private individual for space exploration prior to said launch of the first spacecraft from the earth.

17. The method of claim 16, wherein the private individual provides payment for the training received.

18. The method of claim 1, further comprising using a computer to receive payment from the private individual.

19. A lunar travel system comprising: a first spacecraft adapted to carry at least one passenger, the first spacecraft adapted to depart from the earth and travel into the moon's orbit, wherein the at least one passenger comprises at least one fee-paying private individual.

20. The system of claim 19, wherein the first spacecraft is adapted to dock with a space station located in space.

21. The system of claim 20, wherein the space station comprises the International Space Station.

22. The system of claim 19, further comprising a lunar module dockable with the first spacecraft, wherein the lunar module is adapted to transport at least the private individual to the lunar surface.

23. The system of claim 19, further comprising a third spacecraft adapted to fly unmanned into lunar orbit unmanned prior to departure of the first spacecraft from the earth.

24. The system of claim 1, wherein the first spacecraft is adapted to transport at least two passengers, at least one of which is a non-paying individual.

25. The system of claim 24, wherein the non-paying individual is an American Astronaut or a Russian Cosmonaut.

26. The system of claim 19, comprising at least one of:
a computer-implemented online registration system adapted to register the at least one passenger; and
a computer-implemented training system adapted to provide computer-assisted training of the at least one passenger relating to space flight.

28. The method of claim 1, wherein the receiving payment from the private individual is carried out electronically.

29. A computer readable medium embodying logic, which when executed by processor performs a method comprising:
providing a first spacecraft adapted to carry at least one private individual;
receiving payment from the private individual for registration for a flight on the first spacecraft;
providing launching of the first spacecraft from the earth carrying the private individual; and
providing travel into lunar orbit for the private individual in the first spacecraft.
